(19) United States
(12) Patent Application Publication
(10) Pub. No.: US 2009/0199300 A1
(43) Pub. Date: Aug. 6, 2009

(54) WIRELESS COMMUNICATION APPARATUS AND CONFIGURING METHOD FOR WIRELESS COMMUNICATION APPARATUS

(75) Inventor: Shinzo Matsubara, Akishima-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/356,365

(22) Filed: Jan. 20, 2009

(30) Foreign Application Priority Data
Jan. 31, 2008 (JP) 2008-021411

(51) Int. Cl. H04N 7/16

(52) U.S. Cl. 726/26

(57) ABSTRACT

According to one embodiment, a wireless communication apparatus comprises a wireless communication module configured to carry out wireless communication, a first storage module configured to store information unique to the wireless communication apparatus, a configuration generator module configured to generate configuration information for the wireless communication module to connect to a given network based on the information stored in the first storage module, a second storage module configured to store the configuration information generated by the configuration generator module and a first display control module configured to control display of the configuration information stored in the second storage module so that a user cannot recognize the information unique to the wireless communication apparatus.

### CROSS-REFERENCE TO RELATED APPLICATIONS

This application is based upon and claims the benefit of priority from Japanese Patent Application No. 2008-021411, filed Jan. 31, 2008, the entire contents of which are incorporated herein by reference.

### BACKGROUND

1. Field

One embodiment of the invention relates to a wireless communication apparatus and a configuring method for the wireless communication apparatus.

2. Description of the Related Art

The AirStation One-touch Secure System (AOSS) and the WiFi Protected Setup (WPS) are available as techniques for simplifying complicated connection and security setting for a local area network (LAN). According to the techniques, merely pushing buttons provided on a wireless-LAN access point and a wireless communication apparatus enables setting of a wireless LAN. When using a public wireless LAN service provided in a railway station, a hotel or the like, however, it may be difficult for a user to push the button of the wireless-LAN access point because the wireless-LAN access point is attached to, for example, the ceiling.

To utilize a public wireless LAN service, the user needs to enter an ID and a password issued to the user by a communication carrier that provides the public wireless LAN service. It is troublesome for the user to input the ID and the password, particularly when the user utilizes a portable apparatus having no hardware keyboard but a software keyboard. This may increase the probability that the user makes error in inputting the ID and the password.

In view of this, information necessary for setting the wireless LAN connection may be stored in the portable apparatus at the time of manufacturing thereof. For example, Jpn. Pat. Appln. KOKAI Publication No. 2003-87427 discloses an Internet connecting apparatus and a connection assuring method in which setting information that is required to make a call to the Internet service provider is stored in setting information storage. Storing of the setting information is performed either by the manufacturer before shipping the apparatus or by operation made by the user.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing an electronic configuration of an information apparatus (wireless LAN apparatus) having a wireless LAN communication function, according to an embodiment of the present invention;

FIG. 2 is an exemplary view showing an example of predetermined configuration information written in a ROM at the time of manufacturing the wireless LAN apparatus;

FIG. 3 is an exemplary flowchart showing processing for setting connection to a predetermined network;

FIG. 4 is an exemplary view showing an example of data stored in a configuration information table;

FIG. 5 is an exemplary flowchart showing display processing for predetermined configuration information;

FIG. 6 is an exemplary flowchart showing processing for confirming a validity period;

FIG. 7 is an exemplary view showing another example of data stored in the configuration information table; and

FIG. 8 is an exemplary flowchart showing reset processing for configuration information on the predetermined network.

### DETAILED DESCRIPTION

Various embodiments according to the invention will be described hereinafter with reference to the accompanying drawings. In general, according to one embodiment of the invention, a wireless communication apparatus comprises a wireless communication module configured to carry out wireless communication, a first storage module configured to store information unique to the wireless communication apparatus, a configuration generator module configured to generate configuration information for the wireless communication module to connect to a given network based on the information stored in the first storage module, a second storage module configured to store the configuration information generated by the configuration generator module and a first display control module configured to control display of the configuration information stored in the second storage module so that a user cannot recognize the information unique to the wireless communication apparatus.

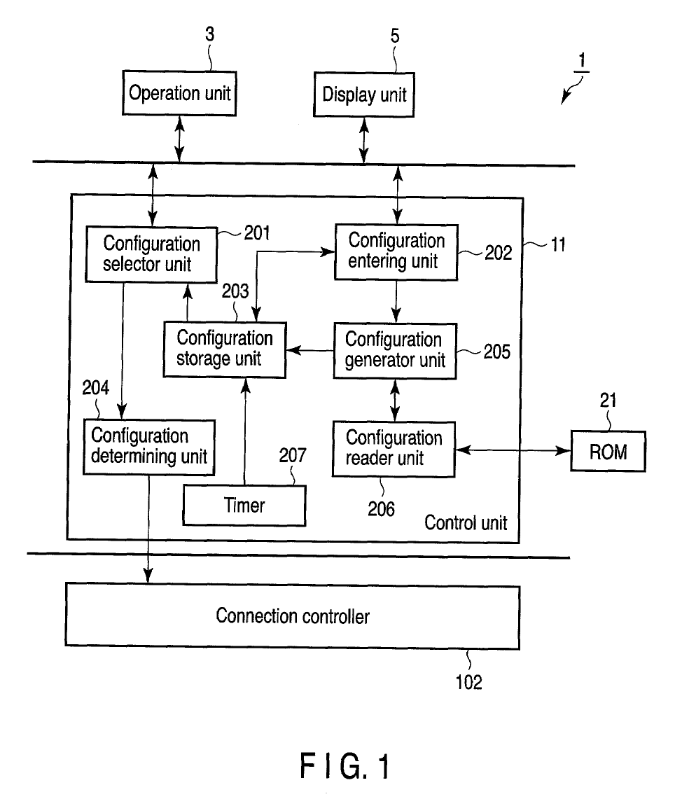

FIG. 1 is an exemplary block diagram showing an electronic configuration of an information apparatus (wireless LAN apparatus) 1 having a wireless LAN communication function, according to an embodiment of the present invention. For example, a personal digital assistant (PDA), a portable media player (PMP) and a mobile phone may be used as the wireless LAN apparatus 1.

The wireless LAN apparatus 1 includes a control unit 11 having a CPU and a memory, which are not shown. The control unit 11 controls various components of the wireless LAN apparatus 1.

The user can enter an operation instruction, a selection instruction and the like by operating an operation unit 3. A control signal corresponding to operation of the operation unit 3 made by the user is supplied to the control unit 11 through a bus. A display unit 5 includes, for example, a liquid crystal display and can display image data including a moving image, a still image and character information, in accordance with instructions from the control unit 11.

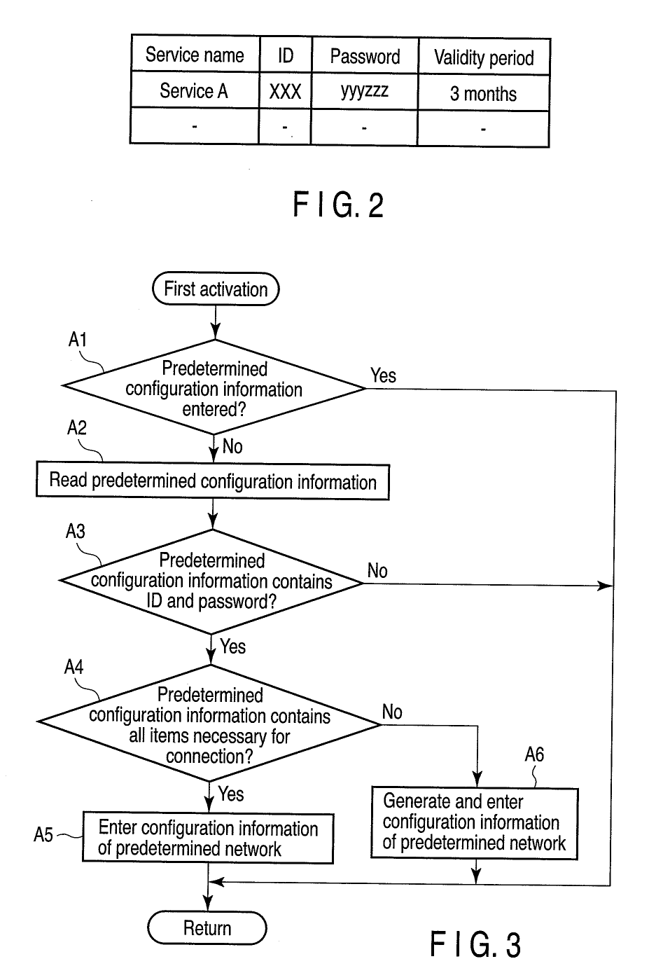

A ROM 21 is connected to the control unit 11. The ROM 21 prestores program data which the control unit 11 executes to control the components of the wireless LAN apparatus 1. In a given storage area of the ROM 21, predetermined configuration information (see FIG. 2), which will be described later, is prestored at the time of manufacturing the wireless LAN apparatus 1.

The wireless LAN apparatus 1 can transmit and receive data to and from an external apparatus. A connection controller 102 is used for connecting to a wireless communication network such as a wireless LAN. Data is exchanged through the connection controller 102. The connection controller 102 may be compatible with the Bluetooth (registered trademark) complying with a protocol of a (high-speed) communication standard using 2.4 GHz-band waves, or the connection controller 102 may be compatible with a general-purpose wireless LAN that is compliant with IEEE802.11a/b/g/n. Alternatively, the connection controller 102 may be compatible with both the Bluetooth and the general-purpose wireless LAN. Through the connection controller 102, the wireless LAN apparatus 1 can achieve wireless communication with an external apparatus such as a server computer or a personal computer, which is located within a specific range from the wireless LAN apparatus 1 and meets a given condition.

Data from an external apparatus can be supplied to the wireless LAN apparatus 1 through the connection controller 102. Data stored in a storage device (e.g., hard disk drive or flash memory, not shown) of the wireless LAN apparatus 1 can be provided through the connection controller 102 to the external apparatus.

The wireless LAN apparatus 1 can be wirelessly connected to an access point via the connection controller 102. In addition, the wireless LAN apparatus 1 can be connected to a network such as the Internet through the access point. The wireless LAN apparatus 1 can download various contents distributed on the network, such as audio data, video data and data contents. Downloaded contents are stored in the storage device. The wireless LAN apparatus 1 can reproduce the downloaded contents. Reproduction of the contents is performed in accordance with a given reproduction program prestored in the ROM 21.

The wireless LAN apparatus 1 can also be connected to an external apparatus via a USB port and can transmit and receive data to and from the external apparatus.

The control unit 11 includes a configuration selector unit 201, a configuration entering unit 202, a configuration storage unit 203, a configuration determining unit 204, a configuration generator unit 205, a configuration reader unit 206 and a timer 207. The control unit 11 sets wireless-LAN configurations and controls the wireless LAN communication.

The configuration entering unit 202, the configuration generator unit 205 and the configuration reader unit 206 are used mainly to enter configuration information required for the wireless LAN connection and to alter the entered configuration information. The configuration storage unit 203 is a memory unit that stores the entered configuration information. The configuration selector unit 201 receives a selection instruction input by the user, and the configuration determining unit 204 configures the wireless LAN connection in accordance with the selection. The timer 207 performs a time measuring operation.

Operations of the wireless LAN apparatus 1 will now be explained.

In the wireless LAN apparatus 1 that is an information apparatus having a wireless communication function, configuration of the wireless LAN communication is normally set as described below.

First, the user of the wireless LAN apparatus 1 operates the operation unit 3 to input configuration information including a network name (SSID), a security type, an encryption type and an encryption key of a wireless-LAN access point that the user desires to use. Then, the user instructs the configuration entering unit 202 to enter the input configuration information. The configuration entering unit 202 receives the instruction to enter the input configuration information made by operation of the operation unit 3. The configuration entering unit 202 transmits the configuration information on the wireless-LAN access point to the configuration generator unit 205. The configuration generator unit 205 converts the configuration information into a format which the connection controller 102 can use. The converted configuration information is stored in the configuration storage unit 203. Thus, the configuration information is entered as configuration information for the connection controller 102 to access the wireless-LAN access point.

The configuration entering unit 202 reads configuration information on a wireless-LAN access point from the configuration storage unit 203. The read configuration information is supplied to the display unit 5. The display unit 5 can therefore show the configuration information to the user. In the case where the configuration storage unit 203 also stores a configuration for another wireless-LAN access point, the configuration entering unit 202 can read configuration information on the other wireless-LAN access point and supplies the read configuration information to the display unit 5; therefore, the display unit 5 can show the user the read configuration information.

The user can edit configuration information displayed on the display unit 5 by operating the operation unit 3. The configuration entering unit 202 receives an instruction given by the user to enter the edited configuration information, and transmits the edited configuration information to the configuration generator unit 205. The configuration generator unit 205 converts the edited configuration information into a format which the connection controller 102 can use. The converted configuration information is stored into the configuration storage unit 203.

Wireless LAN communication using the wireless-LAN configuration information entered and stored in the configuration storage unit 203 will be performed as described below.

To carry out wireless LAN communication, the configuration selector unit 201 reads out information of one or more wireless-LAN access points stored in the configuration storage unit 203 and displays the read information on the display unit 5 to show the information to the user.

It is sufficient that the configuration selector unit 201 causes the display unit 5 to display merely information that enables the user to recognize the wireless-LAN access point or points. For example, only the service name of the network may be displayed.

By operating the operation unit 3, the user can select a desired one from the one or more wireless-LAN access points displayed on the display unit 5. When the user selects a desired wireless-LAN access point, the configuration selector unit 201 transmits information on the wireless-LAN relating to the selected access point to the configuration determining unit 204.

The configuration determining unit 204 determines the configuration of the connection controller 102 in accordance with the transmitted configuration information. The connection controller 102 makes a connection to the selected wireless-LAN access point in accordance with the determined configuration and communicates wirelessly with the wireless LAN access point.

In the normal wireless-LAN connection configuration described above, configuration information includes many items such as a network name (SSID), an encryption type and an encryption key of the wireless-LAN access point, and the user may have difficulty in inputting characters in the case of utilizing a portable apparatus such as a PDA, a PMP or a mobile phone. Therefore, the user may not readily utilize the wireless LAN.

The wireless LAN apparatus 1 according to the present embodiment is so designed that wireless LAN communication is configured in the following manner in addition to the above-described normal wireless LAN configuration.

In a given storage area in the ROM 21 of the wireless LAN apparatus 1 according to the present embodiment, configuration information to utilize a network provided by a predefined public wireless-LAN service provider is stored at the time of manufacturing. The configuration information includes an identification name to identify the network (service name of the service that the provider provides) and an ID and a password unique to the wireless LAN apparatus 1. When a validity period is set for the ID and the password, information representing the validity period is also written in the ROM 21.

The ID and the password written in the ROM 21 at the time of manufacturing may be a trial-use ID and a trial-use password which are prepared by the provider in order that the user can easily utilize the wireless LAN on trial, simplifying the wireless LAN connection configuration. After the trial use of the wireless LAN, the user may acquire a proper license (proper ID and proper password) from the provider if necessary. Accordingly, a predefined validity period may be set for the trial-use ID and the trial-use password. After the user connected the apparatus 1 to the public wireless LAN for the first time, when the validity period expires, the wireless LAN apparatus 1 can no longer be connected to the public wireless LAN using the trial-use ID and the trial-use password. If the trial-use ID and the trial-use password are visible to the user, there may be a case in which the user memorizes the ID and the password to use them on another apparatus. Such a case may run counter to intension of the provider.

Hereinafter, a wireless LAN service for which configuration information is written at the time of manufacturing thereof will be referred to as “predetermined network,” and the configuration information concerning the predetermined network will be referred to as “predetermined configuration information.”

When the ROM 21 has an ample storage capacity, all items of configuration information for connecting to an access point of the predetermined network, including a service name (ID name), a network name (SSID), an encryption key, an ID and a password, can previously be written in the ROM 21. When the ROM 21 does not have the ample storage capacity, only the service name of the predetermined network and the ID and the password unique to the wireless LAN apparatus 1 may be written in the ROM 21.

A network name, an encryption key, a security type and an encryption type of a public wireless LAN service are previously decided and will remain unchanged for long periods. Hence, when such items of configuration information are held in the configuration generator unit 205, it is sufficient that only the service name, the ID and the password required to connect to an access point of the predetermined network is stored in the storage area of the ROM 21. The configuration generator unit 205 can generate other items of the configuration information associated with the service name, the ID and the password written in the ROM 21, based on information that the configuration generator unit 205 holds such as the network name and of the encryption key of the public wireless LAN service.

Alternatively, wireless LAN communication configuration of the predetermined network may be entered beforehand in the configuration storage unit 203, not in the storage area of the ROM 21.

FIG. 2 is an exemplary view showing an example of the predetermined configuration information written in the ROM 21 at the time of manufacturing the wireless LAN apparatus 1. The configuration information shown in FIG. 2 includes an ID, a password and a validity period which are provided by a provider of a public wireless LAN service (Service A) that is the predetermined network.

The configuration information on an access point of the predetermined network is read from the ROM 21 and set when the wireless LAN apparatus 1 is activated for the first time. FIG. 3 is an exemplary flowchart showing processing for setting connection to the predetermined network, which is executed when the wireless LAN apparatus 1 is activated for the first time.

When the processing is activated, the configuration generator unit 205 determines whether or not wireless LAN configuration information of the predetermined network (predetermined configuration information) has been already entered and stored in the configuration storage unit 203 (Block A1). When the predetermined configuration information has been entered in the configuration storage unit 203 (Yes in Block A1), the processing is terminated.

When the predetermined configuration information has not been entered in the configuration storage unit 203 (No in Block A1), the configuration generator unit 205 instructs the configuration reader unit 206 to read the predetermined configuration information from the ROM 21. The configuration reader unit 206 reads the predetermined configuration information stored in a given storage area of the ROM 21 and supplies the read predetermined configuration information to the configuration generator unit 205 (Block A2). The configuration generator unit 205 determines whether or not the predetermined configuration information contains an ID and a password (Block A3). When the predetermined configuration information does not contain an ID and a password (No in Block A3), the configuration generator unit 205 cannot generate configuration information for connecting to an access point of the predetermined network. The processing is therefore terminated.

On the other hand, when the predetermined configuration information contains the ID and the password (Yes in Block A3), the configuration generator unit 205 determines whether or not the predetermined configuration information contains all items of information that is necessary for connecting to an access point of the predetermined network in addition to the ID and the password (Block A4).

When the predetermined configuration information contains all items of information necessary for connecting to an access point of the predetermined network in addition to the ID and the password (Yes in Block A4), the configuration generator unit 205 converts the predetermined configuration information into a format that the connection controller 102 can use and the converted configuration information is entered and stored in a configuration information table provided in the configuration storage unit 203 (Block A5). When the predetermined configuration information contains information on a validity period of the ID and the password, the information on the validity period is also stored in the configuration information table.

When the predetermined configuration information does not contain all items of information required for connecting to an access point of the predetermined network (No in Block A4), the configuration generator unit 205 generates items of the configuration information such as a network name and an encryption key of the predetermined network based on the service name, the ID and the password contained in the predetermined configuration information and converts the configuration information into the format which the connection controller 102 can use, then the converted configuration information is entered and stored in the configuration storage unit 203 (Block A6). When the predetermined configuration information contains information on a validity period of the ID and the password, the information on the validity period is also stored in the configuration information table.

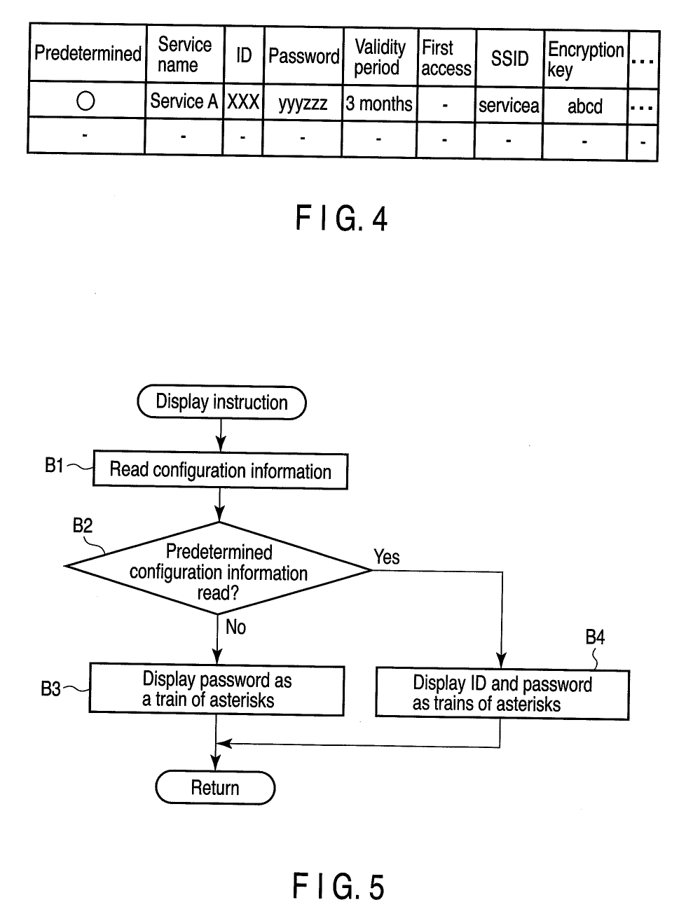

FIG. 4 is an exemplary view showing an example of data stored in the configuration information table provided in the configuration storage unit 203. In FIG. 4, the configuration information table stores configuration information required to connect to an access point of the predetermined network (Service A) generated based on the predetermined configuration information shown in FIG. 2. An item of information which indicates the predetermined configuration information may be affixed to the configuration information of the predetermined network. Further, when the wireless LAN apparatus 1 is connected to the predetermined network for the first time, the date and time of the first access are stored in the configuration information table.

As described above, when the setting processing shown in FIG. 3 is performed at the time of the first activation of the wireless LAN apparatus 1, the configuration information for connecting to an access point of the predetermined network is automatically entered in the configuration storage unit 203. Hence, the user need not carry out the wireless LAN setting.

Thus, once the wireless LAN apparatus 1 is activated and the predetermined configuration information for the predetermined network is entered, the configuration selector unit 201 can read information on the predetermined network from the configuration storage unit 203 and the display unit 5 can therefore display the information on the predetermined network. The user can utilize the wireless LAN network, merely by operating the operation unit 3 and selecting the predetermined network displayed on the display unit 5.

In addition, it is required that the same ID and the same password as written in the ROM 21 at the time of manufacturing the wireless LAN apparatus 1 are also entered in an authentication server of the provider, which authenticates connection from the wireless LAN apparatus 1 depending on the ID and the password. Before shipping the wireless LAN apparatus 1, the manufacturer of the wireless LAN apparatus 1 may enter the ID and the password in the authentication server. Otherwise, the provider may enter the ID and the password in the authentication server and then provide the ID and the password to the manufacturer of the wireless LAN apparatus 1. The ID and the password previously entered in the authentication server are written in the ROM 21 of the wireless LAN apparatus 1 when the wireless LAN apparatus 1 is manufactured. Therefore, the user need not input the ID and the password to carry out the wireless LAN communication.

A method of preventing the user using the configuration information, which is written in the ROM 21 at the time of manufacturing the wireless LAN apparatus 1, in any apparatus other than the wireless LAN apparatus 1, will be explained.

The provider may not wish that the ID and the password written at the time of manufacturing the wireless LAN apparatus 1 are used in any other wireless LAN apparatus. For example, usage of MAC addresses enables identifying uniquely wireless apparatuses. Hence, when the MAC address of the wireless LAN apparatus 1, and the ID and the password of the predetermined network are managed in association, the ID and the password for connecting to the predetermined network can be valid only in this specific wireless LAN apparatus 1. However, according to this managing method, the authentication server should manage the MAC addresses, and load to be imposed on the authentication server will be increased.

Therefore, in the wireless LAN apparatus 1 according to the present embodiment, the following processing is executed when displaying the predetermined configuration information read by the configuration entering unit 202 from the configuration storage unit 203.

FIG. 5 is an exemplary flowchart showing display processing executed to display the predetermined configuration information on the display unit 5.

On receiving an instruction to display configuration information in response to operation of the operation unit 3 made by the user, the configuration entering unit 202 reads the configuration information from the configuration information table (see FIGS. 4 and 7) in accordance with the instruction (Block B1).

The configuration entering unit 202 determines whether or not the read configuration information is the predetermined configuration information (Block B2). When the read configuration information is not the predetermined configuration information (No in Block B2), the password is displayed on the display unit 5 in the form of a train of asterisks, i.e., “. . . ,” while displaying the other items of the read configuration information as it is (Block B3). That is, when the read configuration information is not the predetermined configuration information, the display unit 5 may display the ID as is whereby the user can visually recognize the ID.

On the other hand, when the read configuration information is the predetermined configuration information (Yes in Block B2), the ID and the password for connecting to the predetermined network are displayed as trains of asterisks, i.e., “. . . ” (Block B4). Other items of the read configuration information may be displayed as is on the display unit 5.

Therefore, the user cannot recognize the characters used in the ID of the predetermined configuration information. Hence, the user cannot read the ID and the password and also cannot input them in another wireless apparatus. As the ID and the password are displayed so that the user cannot recognize them, it can be prevented that the user uses the ID and the password for connecting to the predetermined network utilizing any other wireless LAN apparatus. In this case, it is not necessary to enter and manage MAC addresses in the authentication server. Therefore, the load imposed on the authentication server will be reduced.

In the above description, the password is displayed as a train of asterisks even though the read configuration information is not the predetermined configuration information; however, the password may be displayed in a form recognizable to the user. If necessary, another item of configuration information may also be displayed in a form which is not recognizable to the user.

Next, processing executed when the validity period of the ID and the password expires will be explained.

The provider may set a validity period on an ID and a password to be written at the time of manufacturing the wireless LAN apparatus 1. In the wireless LAN apparatus 1 according to the present embodiment, the following processing can be performed to inform the user that the validity period has expired and the wireless LAN apparatus 1 can no longer be connected to the predetermined network.

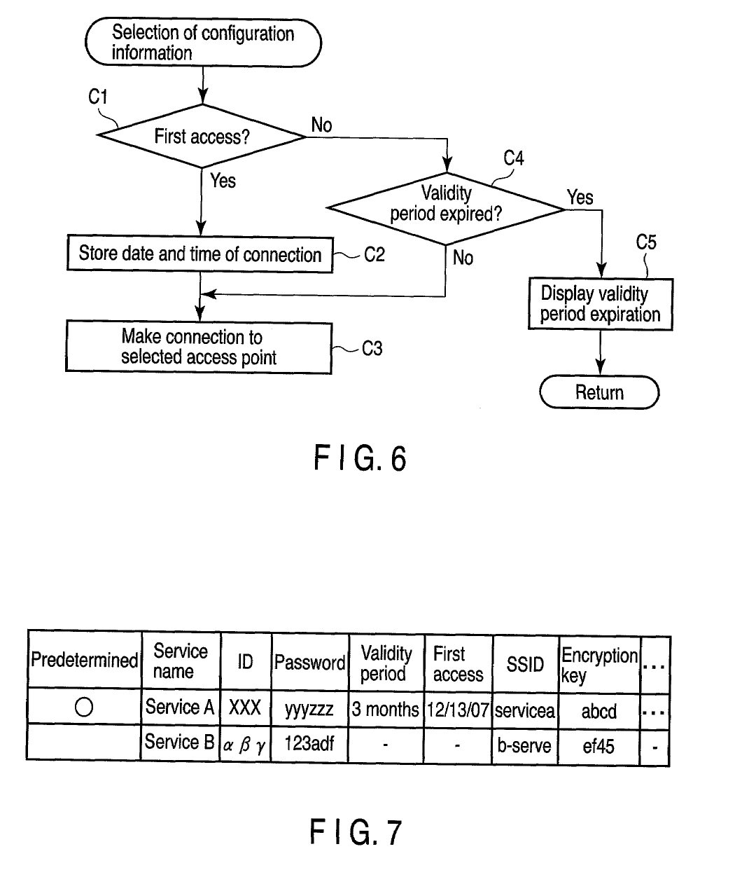

To carry out wireless LAN communication using the wireless LAN apparatus 1, the configuration selector unit 201 reads information on the wireless LAN access point or points from the configuration storage unit 203 and the display unit 5 displays the read information. The user selects a desired access point by operating the operation unit 3. In response to the selection of the wireless-LAN access point made by the user, processing shown in FIG. 6 for confirming the validity period can be executed.

FIG. 6 is an exemplary flowchart showing the processing for confirming the validity period, which is started when the configuration selector unit 201 receives a selection instruction of an access point.

When the user selects a desired access point by operating the operation unit 3, the configuration selector unit 201 determines whether or not it is first connection from the wireless LAN apparatus 1 to the network of the selected access point (Block C1). The determination whether the connection is first access to the selected network or not can be made based on the configuration information on the network stored in the configuration information table. That is, the determination can be made based on whether or not the configuration information contains an item of information representing the date and time of first access. FIG. 7 is an exemplary view showing an example of data stored in the configuration information table. In FIG. 7, configuration information on Service A, which is the predetermined network, contains information representing the date and time of first access. In contrast, configuration information on Service B does not contain information representing the date and time of first access. When Service A is the network of the selected access point, it is determined that the connection is not the first access (No in Block C1). However, when the selected network is Service B, it is determined that the connection is first access to the selected network (Yes in Block C1).

When it is determined that it is the first connection to the selected network (Yes in Block C1), the current date and time which the timer 207 measures is stored in the configuration information table as the date and time of first access (Block C2), and connection to the selected access point is made (Block C3). That is, the configuration selector unit 201 transmits information on the selected wireless-LAN access point to the configuration determining unit 204 in accordance with the selection made by the user. The configuration determining unit 204 determines configuration of the connection controller 102 in accordance with the transmitted configuration information. The connection controller 102 makes a connection to the selected wireless-LAN access point, and communicates wirelessly with the access point.

When it is determined that it is not the first access to the selected network (No in Block C1), the validity period of the ID and the password for connecting to the selected access point is read from the configuration information table. It is determined, on the basis of the current time measured by the timer 207, whether or not the read validity period has passed after the date and time of the first access (Block C4). When it is determined that the validity period has not passed or when the validity period is not set (No in Block C4), the connection to the selected access point is made (Block C3).

When it is determined that the validity period has passed (Yes in Block C4), the user is informed of the expiration by means of the display of the display unit 5 (Block C5).

Thus, the user can be informed of the fact that the validity period has expired and the wireless LAN service is no longer available.

In the above description, the processing for confirming the validity period shown in FIG. 6 is executed when the configuration selector unit 201 receives a selection instruction of an access point made by the user. However, whether the validity period has expired or not may be determined periodically comparing a validity period stored in the configuration storage unit 203 with the current time measured by the timer 207.

Subsequently, reset processing for the predetermined configuration information will be explained.

The configuration information on a wireless-LAN access point stored in the configuration information table (see FIGS. 4 and 7) is read by the configuration entering unit 202 and displayed by the display unit 5. The user can edit the configuration information displayed on the display unit 5 by operating the operation unit 3. Therefore, if the user makes wrong operations, the trial-use ID or the trial-use password may be changed or overwritten. As a result, the wireless LAN apparatus 1 may not be connected to the public wireless LAN service.

In such a case, the user enters a blank ID and a blank password in the configuration entering unit 202 by operating the operation unit 3. More specifically, the blank ID and the blank password may be entered in such a manner that the user keeps fields for inputting the ID and the password on the screen of the display unit 5 to be blank and operates an entering button provided on the operation unit 3. Then, the ID and the password for connecting to the predetermined network can be reset in the following procedure.

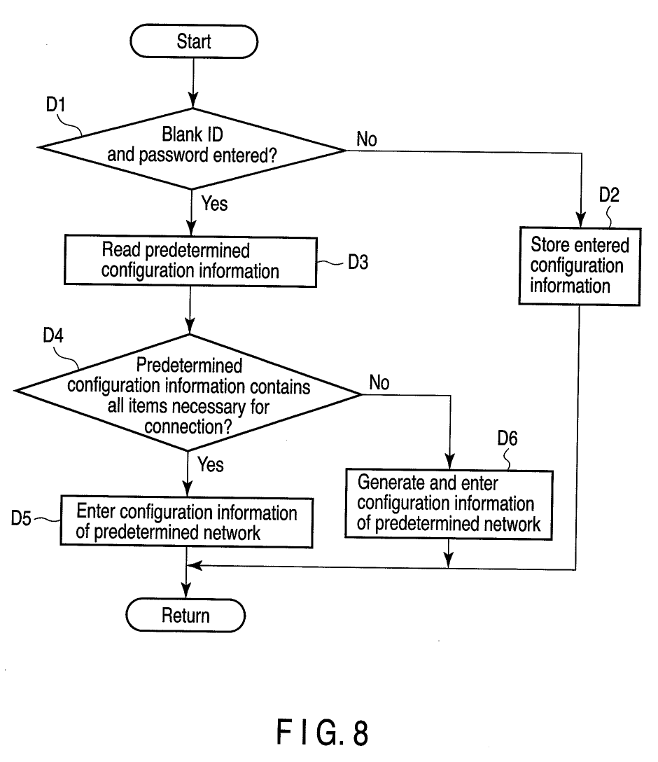

FIG. 8 is an exemplary flowchart showing reset processing for configuration information on the predetermined network. The configuration entering unit 202 determines whether or not the ID and the password contained in the configuration information which the user has instructed to enter are blank (Block D1). When the configuration information which the user has entered does not contain the blank ID and the blank password (No in Block D1), resetting of the ID and the password is not required. In this case, the configuration generator unit 205 converts the entered information and stores the entered information in the configuration information table (Block D2). The processing is thus terminated.

When the entered configuration information includes the blank ID and the blank password (Yes in Block D1), the configuration entering unit 202 sends the blank ID and the blank password to the configuration generator unit 205. The configuration generator unit 205 instructs the configuration reader unit 206 to read configuration information on the predetermined network (predetermined configuration information) from the ROM 21. The configuration reader unit 206 reads the predetermined configuration information from a given storage area of the ROM 21 and sends the predetermined configuration information to the configuration generator unit 205 (Block D3). The configuration generator unit 205 determines whether or not the predetermined configuration information contains all items of information necessary for connecting to an access point on the predetermined network in addition to the service name, the ID and the password (Block D4).

When the predetermined configuration information contains all items of information necessary for connecting to an access point on the predetermined network in addition to the service name, the ID and the password (Yes in Block D4), the configuration generator unit 205 converts the predetermined configuration information into the format the connection controller 102 can use, and enters the converted information in the configuration information table (Block D5).

When the predetermined configuration information does not contain all items of information necessary for connecting to an access point on the predetermined network (No in Block D4), the configuration generator unit 205 generates, based on the service name, the ID and the password contained in the predetermined configuration information, items of configuration information including a name of the predetermined network, a security type, an encryption type and an encryption key of the predetermined network, then, converts the generated configuration information into the format the connection controller 102 can use, and enters the converted configuration information in the configuration information table (Block D6).

As described above, entering a blank ID and a blank password allows the ID and the password for connecting to the predetermined network to be reset.

After the user acquires the proper ID and the proper password for the predetermined network, the validity period of the proper ID and the proper password may expire or the user may edit the proper ID and the proper password by mistake. In such cases, the ID and the password contained in the predetermined configuration information stored in the ROM 21 can be reset according to the processing illustrated in FIG. 8.

As indicated above, the predetermined configuration information for connecting to an access point on the predetermined network is written in the ROM 21 at the time of manufacturing the wireless LAN apparatus 1. The predetermined configuration information is read from the ROM 21 when the wireless LAN apparatus 1 is activated for the first time and the read predetermined information is entered in the configuration storage unit 203. Therefore, the user need not perform a troublesome operation to configure the wireless LAN connection.

In the wireless LAN apparatus 1 according to this embodiment, the display unit 5 displays the ID and the password contained in the predetermined configuration information in such a manner that the user cannot recognize the ID and the password. Therefore, the user cannot input the ID and the password into any other wireless apparatus. In addition, the ID and the password of the predetermined configuration information can be prevented from being used in other wireless apparatus than the wireless LAN apparatus 1.

In a case where a validity period is set for the ID and the password contained in the predetermined configuration information, when the validity period expires, display of the display unit 5 can informs the user of the expiration of the validity period. The user can therefore distinguish a case where the apparatus 1 cannot be connected to the network because of a trouble in the apparatus 1 or the malfunction of the network, from a case where the apparatus 1 cannot be connected to the network because of the expiration of the validity period.

In the wireless LAN apparatus 1, the predetermined configuration information stored in the ROM 21 is read if a blank ID and a blank password are input. In this case, the ID and the password for connecting to the predetermined network can be restored and reset.

In the present embodiment, the configuration information including an ID and a password provided by the provider of one public wireless LAN service and is written in the ROM 21 at the time of manufacturing the wireless LAN apparatus 1. However, the configuration information of a plurality of public wireless LAN services may be previously written in the ROM 21.

In the case where an ID and a password written at the time of manufacturing a wireless apparatus are set uniquely to the apparatus, the authentication server can manage information of the first connection and the number of times of connections for each wireless apparatus. Therefore, when the wireless LAN apparatus 1 receives information indicating that connection to the network cannot be made because of the expiration of a validity period from the authentication server, the display unit 5 may inform the user of the validity expiration.

In the present embodiment, the ID and the password for connecting an access point on the predetermined network are displayed as trains of asterisks, such as “. . . ”. The display form of the ID and the password is not limited to the train of asterisks. The ID and the password may be displayed in any other form, as long as the user cannot recognize the ID and the password. Further, not only the ID and the password, but also another item of information, such as a network name (SSID), may be displayed in such a format as the user cannot recognize the item, by request from the provider.

The above embodiment is described about an example of wireless connection to a network. However, configuration information required for wired connection with a network may be previously stored. Moreover, it is also possible to set or reset the configuration information by processing similar to the processing shown in FIG. 3 or FIG. 8. Further, also in the case where configuration information required for wired connection with a network is previously stored, an ID and a password contained in the configuration information can be displayed so that the ID and the password cannot be recognized by the user, by means of processing similar to the processing shown in FIG. 5. Still further, the validity period can be confirmed in the same manner as the processing shown in FIG. 6.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

The various modules of the systems described herein can be implemented as software applications, hardware and/or software modules, or components on one or more computers, such as servers. While the various modules are illustrated separately, they may share some or all of the same underlying logic or code.

What is claimed is:

1. A wireless communication apparatus comprising:
a wireless communication module configured to wirelessly communicate;
a first storage module configured to store information indicative of the wireless communication apparatus;
a configuration generator configured to generate configuration information for the wireless communication module in order to connect to a network based on the information stored in the first storage module;
a second storage module configured to store the configuration information generated by the configuration generator; and
a first display controller configured to control display of the configuration information stored in the second storage module in such a manner that the information indicative of the wireless communication apparatus is not recognizable to a user.

2. The wireless communication apparatus of claim 1, wherein an identification name of the network is stored in the first storage module, and wherein the configuration generator is configured to generate the configuration information based on the identification name of the network.

3. The wireless communication apparatus of claim 1, wherein the first display controller is configured to control the display of the configuration information by replacing a character in the configuration information stored in the second storage module with a predetermined code.

4. The wireless communication apparatus of claim 1, wherein the information indicative of the wireless communication apparatus comprises an ID and a password for connecting to the network.

5. The wireless communication apparatus of claim 1, wherein the information indicative of the wireless communication apparatus comprises an ID and a password for connecting to the network and a validity period of the ID and the password,
and the wireless communication apparatus further comprising:
a determination module configured to determine whether the validity period has expired or not; and
a second display controller configured to display information indicative of the expiration of the validity period when the determination module determines that the validity period has expired.

6. The wireless communication apparatus of claim 5, further comprising a timer configured to measure time, and wherein
the second storage module is configured to store first access time and date indicative of when the wireless communication module is first connected to the network, and
the determination module is configured to determine whether the validity period has passed from the first access time and date based on current time measured by the timer.

7. The wireless communication apparatus of claim 1, further comprising a receiver configured to receive configuration information entered by a user, and wherein
the configuration generator is configured to generate the configuration information for the wireless communication module based on the information stored in the first storage module, when the receiver receives the entered configuration information.

8. The wireless communication apparatus of claim 7, wherein the configuration generator is configured to generate the configuration information for the wireless communication module based on the information stored in the first storage module when the receiver receives information comprising a blank ID and a blank password.

9. The wireless communication apparatus of claim 1, wherein the information indicative of the wireless communication apparatus for connecting to the network is written in the first storage module at a time of manufacturing the wireless communication apparatus.

10. A configuring method for a wireless communication apparatus which comprises a wireless communication module configured to wirelessly communicate, the configuring method comprising:
generating configuration information for the wireless communication module to connect to a network based on information indicative of the wireless communication apparatus and stored in a first storage module;
storing the generated configuration information in a second storage module; and
controlling display of the configuration information stored in the second storage module in such a manner that the information indicative of the wireless communication apparatus is not recognizable to a user.

11. The configuring method of claim 10, wherein the information stored in the first storage module comprises an identification name of the network, and the configuration information are generated based on the identification name of the network.

12. The configuring method of claim 10, wherein the information indicative of the wireless communication apparatus comprises an ID and a password for connecting to the network.

13. The configuring method of claim 10, wherein the information indicative of the wireless communication apparatus comprises an ID and a password for connecting to the network and a validity period of the ID and the password,
and the configuring method further comprising:
determining whether the validity period has expired or not; and
displaying expiration of the validity period when the validity period has expired.

14. The configuring method of claim 13, further comprising measuring time, and wherein
first access time and date indicative of when the wireless communication module is first connected to the network is stored in the second storage module, and
it is determined whether the validity period has passed from the first access time and date based on measured current time.

15. The configuring method of claim 10, further comprising receiving configuration information entered by a user, and wherein
the configuration information for the wireless communication module is generated based on the information stored in the first storage module when the entered configuration information is received.

16. The configuring method of claim 10, wherein the information indicative of the wireless communication apparatus for connecting to the network is written in the first storage module at a time of manufacturing the wireless communication apparatus.
